(19) United States
(12) Patent Application Publication
(10) Pub. No.: US 2003/0201108 A1
(43) Pub. Date: Oct. 30, 2003

(54) Rotary disc for a disc plough or the like

(75) Inventors: Hans Linden, Ytterby (SE); Folke Ostling, Goteborg (SE)

Correspondence Address: BURNS, DOANE, SWECKER & MATHIS, L.L.P., P.O. Box 1404, Alexandria, VA, 22313-1404, US

(73) Assignee: Aktiebolaget SKF, Goteborg (SE)

(21) Appl. No.: 10/392,085

(22) Filed: Mar. 20, 2003

(30) Foreign Application Priority Data
Mar. 20, 2002 (SE) 0200883-7

(51) Int. Cl. A01B 15/16

(52) U.S. Cl. 172/604

(57) ABSTRACT

A rotary disc for a disc plough or the like includes a circular disc having a circumferential cutting edge and a centrally located hub having a bearing seat for a bearing for mounting on a shaft journal incorporated in a frame. The hub is designed as a separate annular sleeve detachably attachable to the plough disc, with the sleeve having the bearing seat provided in the inner surface of the hub. At least a surface region of the hub is softer than the rings of the bearing to be interconnected to the hub via the seat, and the seat in its surface facing the bearing has a number of surface irregularities arranged, under a mutual axial mounting motion between the seat and the bearing ring to cause a deformation of the softer surface region, thereby forming a mutual grip between the seat and the bearing ring.

This application is based on and claims priority under 35 U.S.C. §119 with respect to Swedish Application No. 0200883-7 filed on Mar. 20, 2002, the entire content of which is incorporated herein by reference.

### FIELD OF THE INVENTION

The present invention generally relates to a circular disc having a circumferential cutting edge and a centrally located hub having a bearing seat for a bearing for mounting on a shaft journal incorporated in a frame. More particularly, the present invention pertains to a rotary disc for a farm equipment such as a disc plough, a disc harrow or the like.

### BACKGROUND OF THE INVENTION

Different forms of rotary discs are used in farm equipment such as disc ploughs, disc harrows and the like. These discs can be shaped as concave discs arranged for plowing the soil and often being rotary supported in a bearing on a shaft journal inclined to the horizontal. Alternatively, the discs can be shaped as flat discs making a primary cut in the soil and also for making grooves for seeds to be sewn therein, with such flat discs often being rotary supported in a bearing on a horizontal shaft journal.

The bearings used for supporting such rotary discs are preferably filled with a high performance grease and sealed at manufacture because the environments in which these discs operate are dirty and wet.

The assembly of the disc is usually made by the manufacturer of the implement to be equipped with the disc. This means that the bearing has to be inserted in the bore of a hub, manufactured and delivered by another factory. Then, the hub from one origin, the bearing from another and maybe the plough disc from a third are thereupon assembled, with the risk for assembly errors due to miss-matching components and inexperienced personnel.

A non-round bore in the hub, for instance, could result in a non-satisfactory rentention, an offset positioning of the disc, and possibly other difficulties. Another requirement is that the bearing should be retained in the mounted position without being able to rotate in relation to the seat. Often it is also desired that the bearing ring or rings shall not be axially movable in the seat unless subjected to intentional dismounting measures. Different types of attachment means have previously been used for effecting such retainment of the bearing, such as tapering adapter sleeves and the like. This, however, means an increased number of components in the bearing assembly and therefore increased costs. Interference fits have also been used, but this requires close manufacturing tolerances and special mounting and dismounting appliances and/or tools. Such accurate machining of the components results in increased manufacturing cost as well as the need for mounting and dismounting appliances and tools which increases the handling work and thereby also the costs.

A need thus exists for a more simple and efficient rotary disc of the type mentioned above having a hub with a bearing seat, which allows the rotary disc to be mounted in a very reliable and safe manner.

### SUMMARY OF THE INVENTION

A rotary disc for farm equipment includes a circular disc having a circumferential cutting edge, a hub separate from the disc and adapted to be detachably connected to a central portion of the disc, with the hub having a bore whose inner periphery provides a bearing seat, and a bearing adapted to be received at the bearing seat with surfaces of the bearing and the bearing seat facing one another. The bearing includes an inner bearing ring, an outer bearing ring and roller elements positioned between the inner and outer bearing rings. The surface of the bearing seat facing the bearing having a plurality of spaced apart raised regions so that deformation to the softer surface region occurs during mounting of the bearing at the bearing seat to produce a mutual grip between the bearing seat and the outer bearing ring.

According to another aspect, a plough disc for farm equipment includes a circular disc having a circumferential cutting edge and a hub provided with a bearing seat for a bearing for mounting on a shaft journal incorporated in a frame, with the hub being a separate annular sleeve adapted to be detachably attached to a central location on the disc. The bearing seat is provided at an inner peripheral surface of the hub, with the hub in which the bearing seat is provided being softer at least in a surface region than an outer bearing ring of the bearing that is to be interconnected to the hub via the bearing seat. A surface of the seat which faces the bearing when the bearing is mounted at the bearing seat having a number of surface irregularities, with deformation of the surface irregularities occurring under a mutual axial mounting motion between the bearing seat and the outer bearing ring to thereby form a mutual grip between the bearing seat and the outer bearing ring.

### BRIEF DESCRIPTION OF THE DRAWING FIGURES

The foregoing and additional features and characteristics of the present invention will become more apparent from the following detailed description considered with reference to the accompanying drawing figures in which like reference numerals designate like elements.

FIG. 1 is a perspective side view of a plough disc with a hub incorporating a bearing.

FIG. 2 is an exploded perspective view of the plough disc shown in FIG. 1, illustrating components of the hub and the bearing.

FIG. 3 is an exploded perspective view of the hub shown in FIG. 2 together with a bearing and inner sleeve.

FIG. 4 is a schematic illustration of one example of a different surface texture or surface irregularities for the bearing seat or the sleeve to which the bearing is to be interconnected.

FIG. 5 is a schematic illustration of another example of a different surface texture or surface irregularities for the bearing seat or the sleeve to which the bearing is to be interconnected.

### DETAILED DESCRIPTION

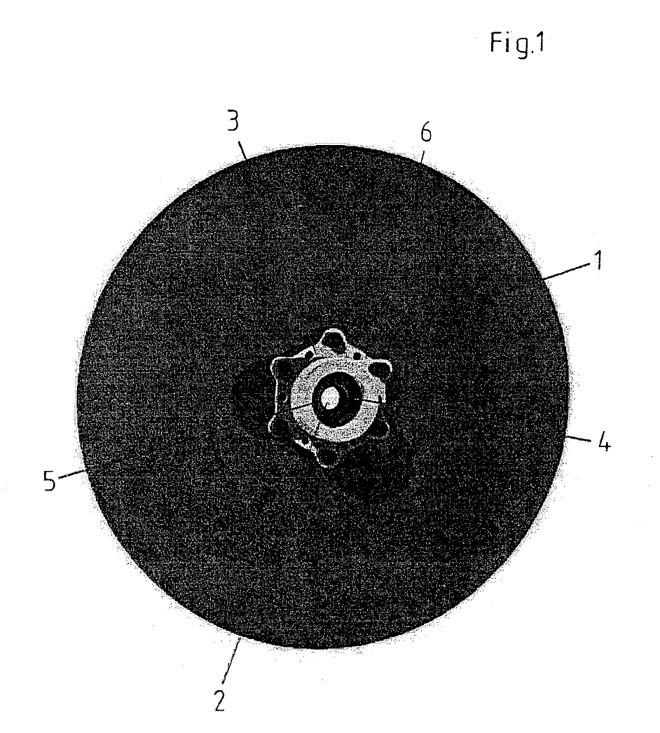

Referring initially to FIG. 1, a plough disc 1 has a substantially circular shape and a cutting edge at its outer periphery or outer envelope surface. The disc has a centrally positioned through-hole 2 and a substantially sleeve-shaped hub 3 fitted to the plough disc 1 around the centrally located through-hole 2.

A bearing 4 includes an outer bearing ring, an inner bearing ring and friction reducing means in the form of rolling elements such as balls or rollers positioned between the inner and outer bearing rings. The bearing 4 is fitted with its outer bearing ring inside the hub 3. In the illustrated embodiment, a shaft journal in the form of a sleeve 5 is provided in the bore of the inner bearing ring.

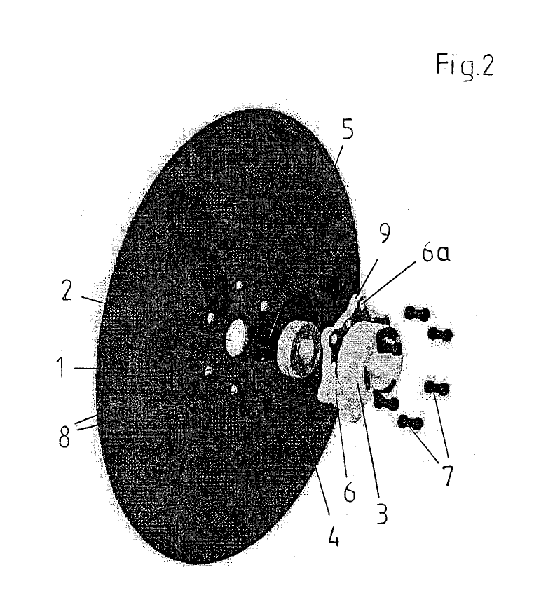

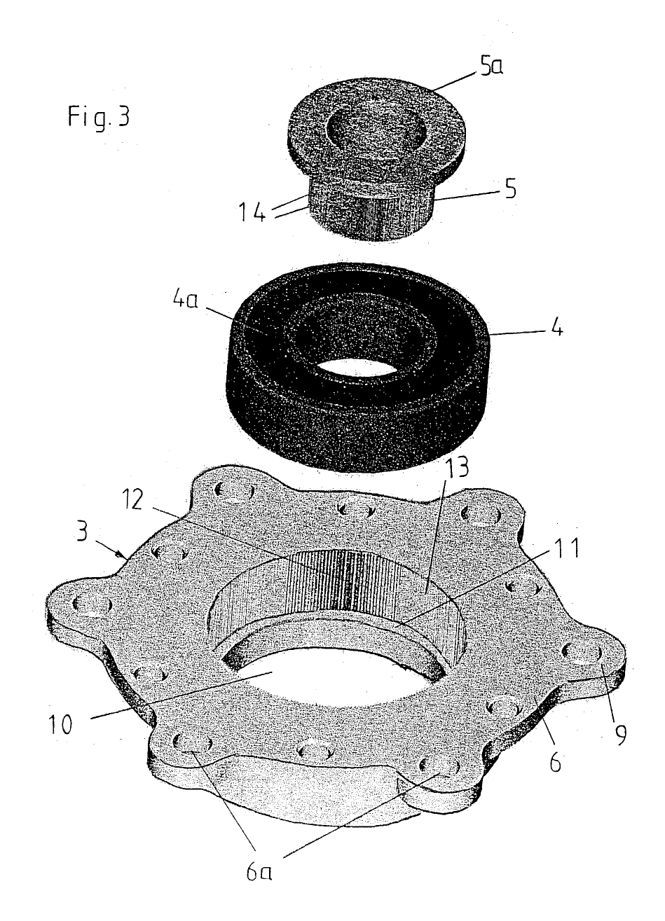

The plough disc 1 can be a flat disc, a circular disc, or a tapering or bowl-shaped disc. The shape of the plough disc in this respect has no significant impact in the context of the description here and so the disc is shown as a flat disc for illustrative purposes. The hub 3 is preferably a compact made from sinter material and is designed as a sleeve having a radial flange 6. The features associated with the hub 3 are better seen in the exploded perspective views of FIGS. 2 and 3.

In the illustrated embodiment, the flange 6 of the hub 3 has a number of axial through-bores 6a which, in the illustrated embodiment, are evenly spaced apart along the circumference of the flange and which are attachable via bolts 7 in corresponding bores 8 provided in the plough disc 1. In the illustrated embodiment, the radial flange 6 is provided with radially projecting lugs 9 through which the through-bores 6a extend. These lugs are not necessary, but can be of benefit from the standpoint of contributing to reducing the overall weight of the hub 3.

FIG. 3 illustrates on a slightly enlarged scale the hub 3 with the bearing 4 and the internal sleeve 5. This view illustrates how the substantially sleeve-shaped hub 3 has a through-bore 10 which is provided, at its end side facing away from the radial flange 6, with a radially inwardly extending shoulder 11. The rolling bearing 4 is provided with integral seals 4a and is adapted to be mounted with its outer bearing ring in the bearing seat 12 defined by the inner periphery or inner envelope surface of the bore 10 of the hub 3.

The seat 12 is equipped with axially extending surface irregularities 13. According to a preferred embodiment illustrated in the drawing figures, the surface irregularities 13 are in the form of spaced apart raised regions such as grooves and ridges, serrations, splines or the like extending substantially in the axial direction of the hub bore 10. As mentioned above, the hub 3, due to its rather complex shape, is preferably made as a sintered compact of a metal powder so that the component can be obtained with a minimum of machining. However, the hub 3 might also be cast, for example from aluminium or other alloys or materials that are softer than the material of the bearing ring.

The material in the hub 3 is softer than that of the bearing rings themselves so that when pushed in axially, the bearing 4 will cause deformation to the surface irregularities 13 in the seat 12, thus causing the deformed portions to arrest the bearing in the hub, particularly against rotation in the seat. When mounted in this manner, the bearing can be axially pushed into the seat until the forward side face of its outer ring engages the shoulder 11.

The assembly also includes the above-mentioned inner sleeve 5, which can be used as a shaft journal or a connection to a non-rotating shaft journal of the plough frame or the like.

The sleeve 5 is preferably, though not necessarily, made as a sintered compact, and has a lower hardness (i.e., is softer) than the bearing rings. At one axial end, the sleeve 5 has a radially projecting shoulder 5a. This projecting shoulder 5a has a diameter larger than the bore in the inner bearing ring of the bearing 4, whereas the outer diameter of the remainder of the sleeve 5 is somewhat larger than the bore of the bearing. The outer periphery or outer envelope surface of the sleeve 5 is provided with axially extending surface irregularities 14 which, due to the lower hardness of the sleeve 5, will be deformed when pushed into the bearing 4, thus generating a firm grip between the bearing and the sleeve. This grip can, however, be released by additional forces acting in the opposite direction and causing a further deformation of the softer material. According to a preferred embodiment illustrated in the drawing figures, the surface irregularities 14 can be in the form of spaced apart raised regions such as grooves and ridges, serrations, splines or the like extending substantially in the axial direction of the sleeve 5.

When mounted in this manner with the bearing 4 being pushed into the bore or seat of the hub 3 in the axial direction and the sleeve 5 being pushed axially into the bore of the inner bearing ring, the deformation of the softer material of the surface irregularities provides a grip around the bearing, thus inhibiting or preventing it from sliding in the bearing seat 12 or against the periphery or envelope surface of the sleeve 5. The deformation of the softer material can also compensate for initial misalignments to a certain degree. This also means that the requirements for manufacturing tolerances can be maintained at a comparatively low level when it comes to the manufacture of the hub 3 and the sleeve 5. Further, with this assembly, it may also be possible to use bearings which, due to certain outer ring defects, would otherwise have been rejected. That is because some of those defects can be compensated by the deformation of the softer material during the mounting operation. Thus, it is possible to achieve a less expensive and yet reliable mounting, while also permitting the use of components having less accurate tolerances, thus also contributing to a lower cost.

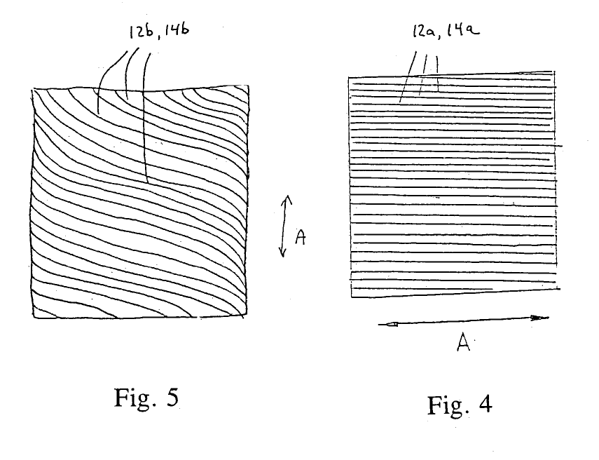

Although the surface irregularities 12, 14 have been illustrated schematically as axially extending splines, serrations or grooves and ridges, it is also possible to arrange the surface irregularities at an angle to the axial direction A such as the surface irregularities 12a, 14a shown in FIG. 4 or so that the surface irregularities possess a helical extension with respect to the axial direction A such as the surface irregularities 12b, 14b shown in FIG. 5, the latter of which would permit the bearing to be “screwed” into the seat in the hub upon mounting.

The principles, preferred embodiments and modes of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims be embraced thereby.

What is claimed is:

1. A rotary disc for farm equipment comprising:
a circular disc having a circumferential cutting edge;
a centrally located hub separate from the disc and adapted to be detachably connected to the disc, the hub having a bore whose inner periphery provides a bearing seat;
a bearing adapted to be received at the bearing seat with surfaces of the bearing and the bearing seat facing one another, the bearing comprising an inner bearing ring, an outer bearing ring and roller elements positioned between the inner and outer bearing rings;
the surface of the bearing seat facing the bearing having a plurality of spaced apart raised regions so that deformation to the softer surface region occurs during mounting of the bearing at the bearing seat to produce a mutual grip between the bearing seat and the outer bearing ring.

2. The rotary disc according to claim 1, wherein the surface region of the hub is made from a sintered material.

3. The rotary disc according to claim 1, wherein the hub is made from sintered material.

4. The rotary disc according to claim 1, wherein the bearing seat is a cylindrical seat formed by the bore in the hub and an inwardly directed shoulder.

5. The rotary disc according to claim 1, wherein the spaced apart raised regions comprise grooves and ridges extending substantially in an axial direction of the bearing seat.

6. The rotary disc according to claim 1, wherein the spaced apart raised regions comprise grooves and ridges extending at an angle to an axial direction of the seat.

7. The rotary disc according to claim 1, wherein the spaced apart raised regions comprise grooves and ridges extending helically along the bearing seat.

8. The rotary disc according to claim 1, including a sleeve forming a shaft journal, the sleeve being adapted to be received in a bore of the inner bearing ring of the bearing and being provided with an outer surface portion made of a material softer than that of the inner bearing ring, the outer surface of the sleeve being provided with spaced apart raised regions adapted to be deformed upon mounting the sleeve in the bore of the inner bearing ring.

9. The rotary disc according to claim 8, wherein the sleeve is manufactured from a sinter material.

10. A plough disc for farm equipment comprising a circular disc having a circumferential cutting edge and a hub provided with a bearing seat for a bearing for mounting on a shaft journal incorporated in a frame, the hub being a separate annular sleeve adapted to be detachably attached to a central location on the disc, the bearing seat being provided at an inner peripheral surface of the hub, the hub in which the bearing seat is provided being softer at least in a surface region than an outer bearing ring of the bearing that is to be interconnected to the hub via the bearing seat, a surface of the seat which faces the bearing when the bearing is mounted at the bearing seat having a number of surface irregularities, with deformation of the surface irregularities occurring under a mutual axial mounting motion between the bearing seat and the outer bearing ring to thereby form a mutual grip between the bearing seat and the outer bearing ring.

11. The plough disc according to claim 10, wherein the surface region of the hub is provided at an inner surface of a bore in the hub, at least the surface region of the hub being made from a sintered material.

12. The plough disc according to claim 10, wherein the hub in which the bearing seat is provided is made from sintered material.

13. The plough disc according to claim 10, wherein the hub is provided with an internal cylindrical seat forming the bearing seat in which the outer bearing ring of the bearing is insertable.

14. The plough disc according to claim 10, wherein the hub has a bore constituting the bearing seat, the bore at one end being provided with a radially inwardly projecting annular shoulder forming a stop for the bearing in one axial direction.

15. The plough disc according to claim 10, wherein the surface irregularities are grooves and ridges extending substantially in an axial direction of the bearing seat.

16. The plough disc according to claim 10, wherein the surface irregularities are grooves and ridges extending at an angle to an axial direction of the bearing seat.

17. The plough disc according to claim 10, wherein the surface irregularities are grooves and ridges extending helically along the bearing seat.

18. The plough disc according to claim 10, wherein a sleeve is provided as the shaft journal or a member to be attached to a shaft journal and has at least its external surface being of a material softer than that of an inner bearing ring of the bearing, with surface irregularities on the exterior surface that are adapted to be deformed upon mounting the sleeve in a bore of the inner bearing ring.

19. The plough disc according to claim 10, wherein the sleeve provided as the shaft journal or a member to be attached to a shaft journal is manufactured from a sinter material.
